(19) United States
(12) Patent Application Publication
(10) Pub. No.: US 2011/0144779 A1
(43) Pub. Date: Jun. 16, 2011

(54) DATA PROCESSING FOR A WEARABLE APPARATUS

(75) Inventors: Cornellis Pietre Janse, Eindhoven (NL); Vincent Demanet, Brussels (BE); Julien Laurent Bergere, Leuven (BE)

(73) Assignee: KONINKLIJKE PHILIPS ELECTRONICS N.V., EINDHOVEN (NL)

(21) Appl. No.: 12/293,437

(22) PCT Filed: Mar. 20, 2007
(86) PCT No.: PCT/IB2007/050964

§ 371 Date: Sep. 18, 2008

(30) Foreign Application Priority Data
Mar. 24, 2006 (EP) 06111688.5

(51) Int. Cl. G06F 17/00

(52) U.S. Cl. 700/94

(57) ABSTRACT

A device (120) for processing data for a wearable apparatus (100, 110), the device (120) comprising an input unit (122) adapted to receive input data, means (124, 116, 117) for generating information, referred to as wearing information (WI), which is based on sensor information and indicates a state, referred to as wearing state, in which the wearable apparatus (100) is worn, and a processing unit (121) adapted to process the input data on the basis of the wearing information (WI), thereby generating output data.

### FIELD OF THE INVENTION

The invention relates to a device for processing data for a wearable apparatus.

The invention also relates to a wearable apparatus.

The invention further relates to a method of processing data for a wearable apparatus.

Furthermore, the invention relates to a program element and a computer-readable medium.

### BACKGROUND OF THE INVENTION

Audio playback devices are becoming more and more important. Particularly, an increasing number of users buy portable and/or hard disk-based audio players and other similar entertainment equipment.

GB 2,360,182 discloses a stereo radio receiver which may be part of a cellular radiotelephone and includes circuitry for detecting whether a mono or stereo output device, e.g. a headset, is connected to an output jack and controls demodulation of the received signals accordingly. If a stereo headset is detected, left and right signals are sent via left and right amplifiers to respective speakers of the headset. If a mono headset is detected, right and left signals are sent via the right amplifier only.

US 2005/0063549 discloses a system and a method for switching a monaural headphone to a binaural headphone, and vice versa. Such a system and method are useful for utilizing audio, video, telephonic, and/or other functions in multi-functional electronic devices utilizing both monaural and binaural audio.

However, a human user may find these audio systems inconvenient.

### OBJECT AND SUMMARY OF THE INVENTION

It is an object of the invention to provide a user-friendly device with which efficient data-processing can be realized.

In order to achieve the object defined above, a device for processing data for a wearable apparatus, a wearable apparatus, a method of processing data for a wearable apparatus, a program element, and a computer-readable medium as defined in the independent claims are provided.

In one embodiment of the invention, a device for processing data for a wearable apparatus is provided, the device comprising an input unit adapted to receive input data, means for generating information, referred to as wearing information, which is based on sensor information and indicates a state, referred to as wearing state, in which the wearable apparatus is worn, and a processing unit adapted to process the input data on the basis of the detected wearing information, thereby generating output data.

In another embodiment of the invention, a wearable apparatus is provided, comprising a device for processing data having the above-mentioned features.

In still another embodiment of the invention, a method of processing data for a wearable apparatus is provided, the method comprising the steps of receiving input data, generating information, referred to as wearing information, which is based on sensor information and indicates a state, referred to as wearing state, in which the wearable apparatus is worn, and processing the input data on the basis of the detected wearing information, thereby generating output data.

In a further embodiment of the invention, a program element is provided, which, when being executed by a processor, is adapted to control or carry out a method of processing data for a wearable apparatus having the above-mentioned features.

In another embodiment of the invention, a computer-readable medium is provided, in which a computer program is stored which, when being executed by a processor, is adapted to control or carry out a method of processing data for a wearable apparatus having the above-mentioned features.

The data-processing operation according to embodiments of the invention can be realized by a computer program, i.e. by software, or by using one or more special electronic optimization circuits, i.e. in hardware, or in a hybrid form, i.e. by means of software and hardware components.

In one embodiment of the invention, a data processor for an apparatus which may be worn by a human user is provided, wherein the wearing state is detectable in an automatic manner, and the operation mode of the wearable apparatus and/or of the data-processing device can be adjusted in dependence on the result of detecting the wearing state. Therefore, without requiring a user to manually adjust an operation mode of a wearable apparatus to match with a corresponding wearing state, such a system may automatically adapt the data-processing scheme so as to obtain proper performance of the wearable apparatus, particularly in the present wearing state. Adaptation of the data-processing scheme may particularly include adaptation of a data playback mode and/or a data-recording mode.

For example, when a DJ uses headphones and removes one of the headphones from his head, this can be detected and the reproduction mode of the audio to be played back by the headphones may be modified from a stereo mode to a mono mode.

In another scenario, when a human user operates a massage device as the wearable apparatus, and the system detects that the user desires to use the massage apparatus for massaging his neck, a corresponding neck massage operation mode may be adjusted automatically. However, if a user wishes to massage his head, another head massage operation mode may be adjusted accordingly.

The term “wearable apparatus” may particularly denote any apparatus that is adapted to be operated in conformity or in correlation with a human user's body. Particularly, a spatial relationship between the user's body or parts of his body, on the one hand, and the wearable apparatus, on the other hand, may be detected so as to adjust a proper operation mode. The wearable apparatus shape may be adapted to the human anatomy so as to be wearable by a human being.

The wearing state may be detected by means of any appropriate method, in dependence on a specific wearable apparatus. For example, in order to detect whether an ear cup of a headphone is connected to two ears, one ear or no ear of a human user, temperature sensors, light barrier sensors, touch sensors, infrared sensors, acoustic sensors, correlation sensors or the like may be implemented. It is also possible to electronically detect a positional relationship between a wearable apparatus and a user's body, for example, by providing two essentially symmetrically arranged microphones and by evaluating the output signals of the microphones.

In a further embodiment, signal-processing adapted to conditions of wearing a reproduction device is provided. In this context, a method of hearing enhancement may be provided, for example, in a headset, based on detecting a wearing state. This may include automatic detection of a wearing mode (for example, whether no, one or both ears are currently used for hearing) and switching the audio accordingly. It is possible to adjust a stereo playback mode for a double-earphone wearing mode, a processed mono playback mode for a single-earphone wearing mode, and a cut-off playback mode for a no-earphone wearing mode. This principle may also be applied to other body-worn actuators, and/or to systems with more than two signal channels.

In a further embodiment, a signal-processing device is provided, which comprises a first input stage for receiving an input signal, an output stage adapted to supply an output signal derived from the input signal to headphones (or earphones). A second input stage may be provided and adapted to receive information that is representative of a wearing state of the headphones. A processing unit may be adapted to process the input signal to provide said output signal based on the wearing information.

Signal-processing adapted to conditions of wearing a reproduction device may thus be made possible. An embodiment of the invention applies to a headset or earset (headphone or earphone, respectively) that is equipped with a wearing-detection system, which can tell whether the device is put on both ears, one ear only, or is not put on. An embodiment of the invention particularly applies to sound-mixing properties automatically, when the device is used on one ear only (for example, mono-mixing instead of stereo, change of loudness, specific equalization curve, etc.). Embodiments of the invention are related to processing other signals, for example, of the haptic type, and other devices, for example, body-worn actuators.

Some users use their earphones/earsets/headphones/headsets to listen to stereo audio content with one ear instead of two. Many earphone/earset users listen to stereo audio content with only one ear, leaving the other ear open so as to be able to, for example, have a conversation, hear their mobile phone ringing, etc.

Listening to stereo content with only one ear is also a common situation for DJ headphones, which often provide the possibility of using one ear only by, for example, swiveling the ear-shell part (the back of the unused ear-shell rests on the user's head or ear).

Embodiments of the invention may overcome the problem that a part of the content is not heard by the user, as may occur in a conventional implementation, when only one ear of a headset is used to reproduce a stereo signal wherein the content of the left channel differs from the content of the right channel. In an embodiment of the invention, such a modification of the operation mode (i.e. when a user removes one ear cup) may be detected automatically, and the signal-processing may be adjusted to avoid such problems.

Thus, in accordance with an embodiment of the invention, an automatic stereo/mono switch may be provided so that the user (the DJ) can set his headphone to mono when he uses only one ear.

Such an embodiment is advantageous as compared with conventional approaches (for example, an AKG DJ headphone with a manual mono/stereo switch). In contrast to conventional approaches, such a switch for performing an extra action can thus be dispensed with in accordance with an embodiment of the invention. Consequently, the automatic detection of the wearing mode and a corresponding adaptation of the performance of the apparatus may improve user-friendliness.

Furthermore, the sensitivity of the human hearing system to sounds of different frequencies varies when both or only one ear are subjected to the sound excitation. For example, sensitivity to low frequencies decreases when only one ear is subjected to the sound. When a user changes an operation mode from two-ear operation to one-ear or no-ear operation, the frequency distribution of the audio to be played back may be adapted or modified so as to take the changed operation mode into account. It may thus be avoided that, when only one ear is used, the fidelity of the music reproduction is affected (for example, by a lack of bass).

In an embodiment of the invention, the sound may be processed so as to enhance the sound experience in all listening conditions (two ears or only one ear), and furthermore to do this automatically on the basis of the output of a wearing-detection system.

This may have the advantage that the best or an improved listening experience may be obtained in all conditions (for example, stereo when using two ears, and mono down-mix when using only one ear). The headphones may adapt to the user's wearing style, so as to enhance the listening experience. Furthermore, no user interaction is required due to the combination with a wearing-detection system. The sound is automatically adjusted to the wearing style of the device (one ear or two ears).

In a further embodiment of the invention, audio signals may be adjusted in accordance with a wearing state of a wearable apparatus. However, it is also possible to adapt other types of signals, for example, haptic (touch) signals, for example, for headphones equipped with vibration devices. It is also possible to use embodiments of the invention with one, two or more than two signal channels (for example, audio channels) either for the signal or for the device. For example, an audio surround system may be adjusted in accordance with a user's wearing state. Embodiments of the invention may also be implemented in devices other than headphones and the like (for example, devices used for massage with several actuators).

Fields of application of embodiments of the invention are, for example, sound accessories (headphones, earphones, headsets, earsets, e.g. in a passive or active implementation, or in an analog or digital implementation).

Furthermore, sound-playing devices, such as mobile phones, music and A/V players, etc. may be equipped with such embodiments.

It is also possible to implement embodiments of the invention in the context of body-related devices, such as massage, wellness, or gaming devices.

In another embodiment of the invention, a stereo headset for communication with the detection of ear-cup removal is provided. In such a configuration, for example, in a stereo headphone using two microphones, adaptive beam-forming may be performed. Such a method may include the detection of ear-cup removal by detecting the position of impulse response peaks with respect to a delay time between channels. Furthermore, it is possible to switch the audio from the microphones through the beam former if both microphones are in position, or to bypass the beam former if one ear cup is removed from an ear for single-channel processing.

An embodiment of an audio-processing device comprises a first input signal for receiving a first (for example, left) microphone signal which comprises a first desired signal and a first noise signal. A second signal input may be provided for receiving a second (for example, right) microphone signal which comprises a second desired signal and a second noise signal. A detection unit may be provided and adapted to provide detection information based on changes of the first and the second microphone signal relative to each other and on the amount of similarity between the first and the second microphone signal.

An embodiment of the detection unit may be adapted as an adaptive filter which is adapted to provide the detection information based on impulse response analysis.

In another embodiment of the invention, the audio-processing device may comprise a beam-forming unit adapted to provide beam-forming signals based on the first and second microphone signals. Further signal-processing may be based on the detection information provided by the detection unit.

The audio-processing device may be adapted as a speech communication device additionally comprising a first microphone for providing the first microphone signal and a second microphone for providing the second microphone signal.

Removal of an ear cup of a stereo headphone application for speech communication may be detected, and an algorithm may switch automatically to single-channel speech enhancement.

An embodiment of such a processing system may be used for stereo headphone applications for speech communication.

Thus, in accordance with an embodiment, a stereo headset is provided for communication with the detection of ear-cup removal. In this context, a beam former may be provided for a stereo headset equipped with a microphone on each ear cup, and more specifically it deals with the problem that arises when one of the ear cups is removed from the ear. If no precautions are taken, the desired speech will be considered as undesired interference and will be suppressed. In the solution in accordance with the embodiment, the removal of the ear cup may be detected and the algorithm may switch automatically to single-channel speech enhancement.

Further embodiments of the invention and of the device for processing data for a wearable apparatus will hereinafter be explained by way of example. However, these embodiments also apply to the wearable apparatus, the method of processing data for a wearable apparatus, the program element and the computer-readable medium.

The input unit may be adapted to receive data of at least one of the group consisting of audio data, acoustic data, video data, image data, haptic data, tactile data, and vibration data as the input data. In other words, the input data to be processed in accordance with an embodiment of the invention may be audio data, such as music data or speech data. These may be stored on a storage medium such as a CD, a DVD or a hard disk, or captured by microphones, for example, when speech signals must be processed. Data of other origin may also be processed in accordance with embodiments of the invention in conformity with a wearing state of the apparatus. For example, a headset for a mobile phone that vibrates when a call comes in may be adapted to be operated in a different manner when both ears are coupled to headphones as compared with a case in which only one ear is coupled to the headphone. For example, the intensity of the signal may be increased when the headphone covers only one ear, and the headphone being free of the user's other ear may be prevented from vibrating. A massage apparatus is an example in which haptic or tactile data are used.

The device may comprise an output unit adapted to provide the generated output data. The output data obtained by processing the input data in accordance with the detected wearing information may be audio data that is output via loudspeakers of a headset. Such output data may also be vibration-inducing signals or a haptic feature. Also olfactory data may be output.

The output unit may be adapted as a reproduction unit for reproducing the generated output data. In the case of audio data to be processed, the reproduction unit may be a loudspeaker or other audio reproduction elements.

The detection unit may be adapted to detect at least one component of wearing information of the group consisting of how many ears a human user uses with the wearable device, which body part or parts a human user uses with the wearable device, and whether an ear cup is removed from the user's head. For example, when a user (like a DJ) takes one headphone off his ear, this change of the wearing state may be detected by a temperature, pressure, infrared or signal correlation sensor, and the playback mode may be modified accordingly. When the device is a massage apparatus, the massage operation mode may be adjusted to correspond to a part of the body that a human user couples to the massage apparatus. Such a coupling between the human user and the massage apparatus may be regarded as if the apparatus were “worn” by the user.

The detection unit may be adapted to automatically detect the information which is indicative of the wearing state of the wearable apparatus. Thus, the detection may be performed without any user interaction so that the user can concentrate on other activities and does not have to use a switch for inputting the wearing information manually. However, additional to the automatic detection, the user may also contribute manually so as to refine the wearing information.

The processing unit may be adapted to generate the output data as stereo data when detecting that a human user uses both ears with the wearable device. Additionally or alternatively, the processing unit may be adapted to generate the output data as mono data when detecting that a human user uses one ear with the wearable device. Additionally or alternatively, the processing unit may be adapted to generate no output data at all when detecting that a human user uses no ear with the wearable device.

In a default mode, the device may output stereo, and only when it is detected that only a single ear is used, a switch to mono playback may occur. Alternatively, the default mode may be a mono playback mode, and only when it is detected that both ears are used, a switch to stereo may occur. By taking these measures, it may be ensured that in a one-ear mode, no perceivable signals are lost due to a stereo mode. Similarly, in a two-ear mode, it may be ensured that the whole stereo information may be supplied to the human listener.

The processing unit may be adapted to generate the output data as multiple channel data when detecting that a human user uses at least a predetermined number of ears with the wearable device, the multiple channel data including at least three channels. For example, in addition to audio channels, such a multi-channel system may use image or light information, or smell information. Also audio surround systems (which may use, for example, six channels) may be implemented with more than two channels.

The processing unit may be adapted to generate the output data as an audio mix of the input data on the basis of detecting the number of ears the user uses with the wearable device. This may improve the audio performance.

The device may comprise one or more, particularly two, microphones adapted to receive audio signals, particularly speech signals of a user wearing the device, as the input data. A correlation between the audio signals may serve as a basis for the wearing information to be detected.

More particularly, the device may comprise two microphones arranged essentially symmetrically with respect to an audio source (for example, positioned in or on two ear cups of the headphones and thus symmetrically to a human user's mouth acting as a sound source “emitting” speech). The two microphones may be adapted to receive audio signals as the input data emitted by the audio source, wherein a correlation between the audio signals may serve as a basis for the wearing information. In such a scenario, two microphones may detect, for example, the speech of a human user, whose mouth is situated equidistantly to the two microphones. This speech may be detected as the input audio data. Furthermore, a correlation of these audio data with respect to one another may be detected and used as information on whether two ears or only one ear is used.

The detection unit may comprise an adaptive filter unit adapted to detect the wearing information on the basis of an impulse response analysis of the audio data received by the two microphones. Such a detection mechanism may allow a high accuracy of detecting the wearing state.

The processing unit may comprise a beam-forming unit adapted to provide beam-forming data based on the audio data received by the two microphones. In other words, the received speech may be used and processed in accordance with the wearing information derived from the same data, thus allowing the formation of an output beam that takes both the detected speech and the wearing condition into account.

Further embodiments of the wearable apparatus will now be explained. However, these embodiments also apply to the device for processing data for a wearable apparatus, the method of processing data for a wearable apparatus, the computer-readable medium and the program element.

The wearable apparatus may be realized as a portable device, more particularly as a body-worn device. Thus, the apparatus may be used in accordance with a human user's body position or arrangement.

The wearable apparatus may be a realized as a GSM device, headphones, DJ headphones, earphones, a headset, an earpiece, an earset, a body-worn actuator, a gaming device, a laptop, a portable audio player, a DVD player, a CD player, a hard disk-based media player, an Internet radio device, a public entertainment device, an MP3 player, a hi-fi system, a vehicle entertainment device, a car entertainment device, a portable video player, a mobile phone, a medical communication system, a body-worn device, a wellness device, a massage device, a speech communication device, and a hearing aid device. A “car entertainment device” may be a hi-fi system for an automobile.

However, although the system in accordance with embodiments of the invention primarily intends to improve playback or recording of speech, sound or audio data, it is also possible to apply the system for a combination of audio and video data. For example, an embodiment of the invention may be implemented in audiovisual applications such as a video player in which loudspeakers are used, or a home cinema system.

The device may comprise an audio reproduction unit such as a loudspeaker, an earpiece or a headset. The communication between audio-processing components of the audio device and such a reproduction unit may be carried out in a wired manner (for example, using a cable) or in a wireless manner (for example, via a WLAN, infrared communication or Bluetooth).

These and other aspects of the invention are apparent from and will be elucidated with reference to the embodiments described hereinafter.

### BRIEF DESCRIPTION OF THE DRAWINGS

In the drawings,

FIG. 1 shows an embodiment of the wearable apparatus according to the invention.

FIG. 2 shows an embodiment of a data-processing device according to the invention.

FIG. 3 is a block diagram of a two-microphone noise suppression system.

FIG. 4 shows a single adaptive filter for detecting ear-cup removal in accordance with an embodiment of the invention.

FIG. 5 shows a configuration with two adaptive filters for detecting ear-cup removal in accordance with an embodiment of the invention.

FIG. 6 shows a noise suppressor with a single adaptive filter for ear-cup removal detection in accordance with an embodiment of the invention.

FIG. 7 shows a noise suppressor with two adaptive filters for ear-cup removal detection in accordance with an embodiment of the invention.

### DESCRIPTION OF EMBODIMENTS

The illustrations in the drawings are schematic. In the different drawings, similar or identical elements are denoted by the same reference numerals.

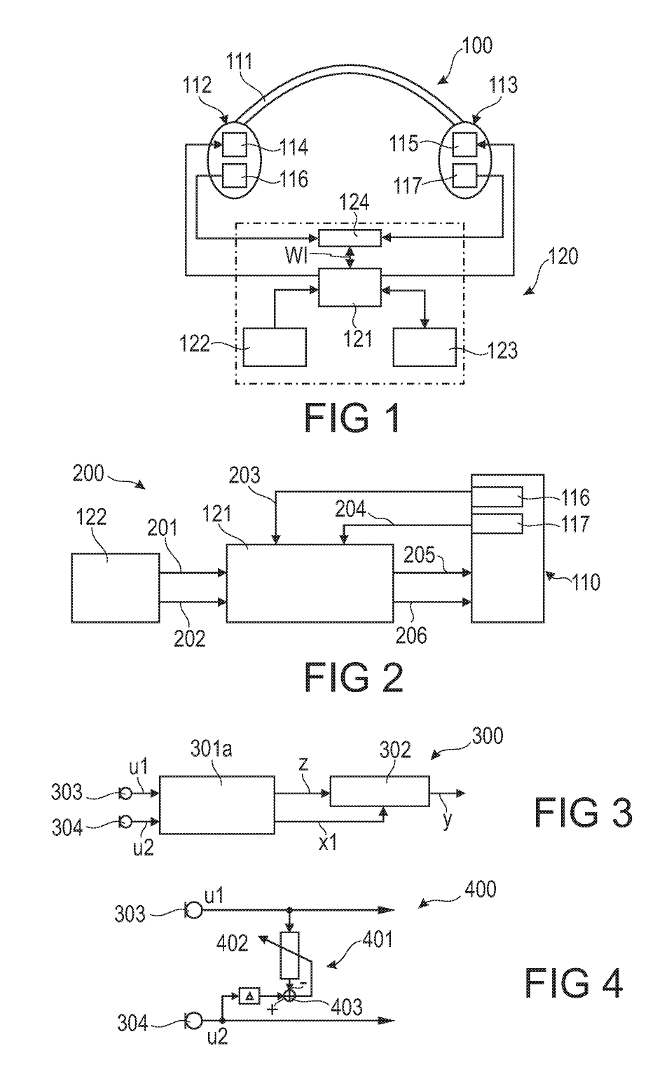

An embodiment of a wearable apparatus 100 according to the invention will now be described with reference to FIG. 1.

In this case, the wearable apparatus 100 is adapted as a headphone comprising a support frame 111, a left earpiece 112 and a right earpiece 113. The left earpiece 112 comprises a left loudspeaker 114 and a wearing-state detector 116; the right earpiece 113 comprises a right loudspeaker 115 and a wearing-state detector 117. The wearable apparatus 100 further comprises a data-processing device 120 according to the invention.

The data-processing device 120 comprises a central processing unit 121 (CPU) as a control unit, a hard disk 122 in which a plurality of audio items is stored (for example, music songs), an input/output unit 123, which may also be denoted as a user interface unit for a user operating the device, and a detection interface 124 adapted to receive sensor information for generating information which is indicative of the state in which the wearable apparatus 100 is worn, hereinafter referred to as wearing state.

The CPU 121 is coupled to the loudspeakers 114, 115, the detection interface 124, the hard disk 122 and the user interface 123 so as to coordinate the function of these components. Furthermore, the detection interface 124 is coupled to the wearing-state detectors 116, 117.

The user interface 123 includes a display device such as a liquid crystal display and input elements such as a keypad, a joystick, a trackball, a touch screen or a microphone of a voice recognition system.

The hard disk 122 serves as an input unit or a source for receiving or supplying input audio data, namely data to be reproduced by the loudspeakers 114, 115 of the headphones. The transmission of audio data from the hard disk 122 to the CPU 121 for further processing is realized under the control of the CPU 121 and/or on the basis of commands entered by the user via the user interface 123.

The wearing-state detectors 116, 117 generate detection signals that are indicative of whether a user carries the headphones on his head, and whether one or two ears are brought in alignment with the earpieces 112, 113. The detector units 116, 117 may detect such a state on the basis of a temperature sensor, because the temperature of the earpieces 112, 113 varies when the user carries or does not carry the headphones. Alternatively, the detection signals may be acoustic detection signals obtained from speech or from an environment so that the correlation between these signals can be evaluated by the CPU 121 so as to derive a wearing state.

The CPU 121 processes the audio data to be reproduced in accordance with the detected wearing state so as to generate reproducible audio signals to be reproduced by the loudspeakers 114, 115 in accordance with the present wearing state.

For example, when a user uses the headphones with one ear only, a mono reproduction mode may be adjusted. When both ears are used, a stereo reproduction mode may be adjusted.

An embodiment of a data-processing device 200 according to the invention will now be described with reference to FIG. 2.

The data-processing device 200 may be used in connection with a wearable apparatus (similar to the one shown in FIG. 1).

As can be seen from the generic system block diagram of FIG. 2, an audio signal source 122 outputs a left ear signal 201 and a right ear signal 202 and supplies these signals to a processing block 121. A wearing-detection mechanism 116, 117 of the headphones 110 supplies a left ear wearing-detection signal 203 and a right ear wearing-detection signal 204 to the CPU 121. The CPU 121 processes the audio signals 201, 202 emitted by the audio signal source 122 in accordance with the left-ear wearing-detection signal 203 and in accordance with the right-ear wearing-detection signal 204 so as to generate a left-ear reproduction signal 205 and a right-ear reproduction signal 206. The reproduction signals 205, 206 are supplied to the headphones 110 (or earphone or headset or earset) for audible reproduction.

Thus, the audio data-processing device 200 of FIG. 2 uses as input wearing information from a detection mechanism 116, 117 so as to be able to discriminate whether no, one or both ears are used for listening. Furthermore, as another input signal, the audio signals 201, 202 are intended to be sent directly to the headphones 110. Signals output towards the headphone 110 are provided (with or without an optional output amplifier stage) to provide reproducible audio signals 205, 206.

Two embodiments will be described hereinafter with reference to the general architecture given in FIG. 2.

A first embodiment relates to a mobile phone or a portable music player. Active digital signal-processing is included in the playing device. The processing block is described in the following Table 1:

TABLE 1

| Wearing detected | Left | Right | Left | Right | Left | Right | Left | Right |
|---|---|---|---|---|---|---|---|---|
| | No | No | Yes | No | No | Yes | Yes | Yes |

| | | | | |
|---|---|---|---|---|
| Left output | No sound | “Processed mono” | No sound | Left, unprocessed |
| Right output | No sound | No sound | “Processed mono” | Right, unprocessed |

The “processed mono” signal in accordance with the above Table is, for example:

the left signal plus (sum) the right signal

10 dB level compared to stereo listening level (to adjust automatically to a situation in which the user wants to stay alert and is able to communicate with others)

bass boost compared to stereo listening conditions (to compensate for lack of sensitivity to bass when only one ear receives the sound).

The sound of the unworn earphones is switched off so as to reduce noise annoyance for neighboring persons.

A second embodiment relates to DJ headphones.

An analog electronic circuit that may be included in the headphones (control box attached on the wire, or electronics included in the ear shells) switches the sound to stereo only when both ears are used for listening:

Details can be taken from the following Table 2:

TABLE 2

| Wearing detected | Left | Right | Left | Right | Left | Right | Left | Right |
|---|---|---|---|---|---|---|---|---|
| | No | No | Yes | No | No | Yes | Yes | Yes |

| | | | | |
|---|---|---|---|---|
| Left output | “Processed mono” | “Processed mono” | “Processed mono” | Left |
| Right output | “Processed mono” | “Processed mono” | “Processed mono” | Right |

In this way, there is always mono sound coming out of both ear shells (always ready to listen towards being played, even if only picking up one ear shell and loosely applying it to the ear for one second). These headphones switch to stereo only when wearing conditions justify it.

Further embodiments which relate to stereo headsets for communication with the detection of ear-cup removal will now be described with reference to FIGS. 3 to 7.

Wireless Bluetooth headsets are becoming smaller and smaller and are more and more used for speech communication via a cellular phone that is equipped with a Bluetooth connection. A microphone boom was nearly always used in the first available products, with a microphone close to the mouth, to obtain a good signal-to-noise ratio (SNR). Because of ease of use, it may be assumed that the microphone boom becomes smaller and smaller. Because of a larger distance between the microphone and the user's mouth, the SNR decreases and digital signal-processing is used to decrease the noise and remove the echoes. A further step is to use two microphones and to do further processing. Philips employs, as part of the Life Vibes™ voice portfolio, the Noise Void algorithm that uses two microphones and provides (non-)stationary noise suppression using beam-forming. The Noise Void algorithm will be used hereinafter as an example of an adaptive beam former, but embodiments of the invention can be used with any other beam former, both fixed and adaptive.

A block diagram of a Noise Void algorithm-based system is depicted in FIG. 3 and will be explained for a headset scenario with two microphones on a boom mounted on an earpiece.

FIG. 3 shows an arrangement 300 comprising an adaptive beam former 301a and a post-processor 302. A primary microphone 303 (the one that is closest to the user's mouth) is adapted to supply a first microphone signal u1, and a secondary microphone 304 is adapted to supply a second microphone signal u2 to the adaptive beam former 301a. Signals z and x1 are generated by the adaptive beam former 301a and are supplied to inputs of the post-processor 302, generating an output signal y based on the input signals z and x1. The beam former 301a is based on adaptive filters and has one adaptive filter per microphone input u1, u2. The used adaptive beam-forming algorithm is described in EP 0,954,850. The adaptive beam former is designed in such a way that, after initial convergence, it provides an output signal z which contains the desired speech picked up by the microphones 303, 304 together with the undesired noise, and an output signal x1 in which stationary and non-stationary background noise picked up by the microphones is present and in which the desired near-end speech is blocked. The signal x1 then serves as a noise reference for spectral noise suppression in the post-processor 302.

The adaptive beam former coefficients are updated only when a so-called “in-beam detection” result applies. This means that the near-end speaker is active and talking in the beam that is made up by the combined system of the microphones 303, 304 and the adaptive beam former 301a. A good in-beam detection is given next: its output applies when the following two conditions are met:

Pᵤ₁>α*Pᵤ₂

P_{z}>β*C*Pₓ₁

Here, Pᵤ₁ and Pᵤ₂ are the short-term powers of the two respective microphone signals, α is a positive constant (typically 1.6), β is another small positive constant (typically 2.0), P_{z} and Pₓ₁ are the short-term powers of signals u1 and u2, respectively, and CPₓ₁ is the estimated short-term power of the (non-)stationary noise in z with C as a coherence term. This coherence term is estimated as the short-term power of the stationary noise component in z divided by the short-term power of the stationary noise component in x1. The first of the two above conditions reflects the speech level difference between the two microphones 303, 304 that can be expected from the difference in distances between the two microphones 303, 304 and the user's mouth. The second of the two above condition requires the speech on x to exceed the background noise to a sufficient extent.

The post-processor 302 depicted in FIG. 3 may be based on spectral subtracting techniques as explained in S. F. Boll, “Suppression of Acoustic Noise in Speech using Spectral Subtraction”, IEEE Trans. Acoustics, Speech and Signal Processing, Vol. 27, pages 113 to 120, April 1979 and in Y. Ephraim and D. Malah, “Speech enhancement using a minimum mean-square error short-time spectral amplitude estimator”, IEEE Trans. Acoustics, Speech and Signal Processing, Vol. 32, pages 1109 to 1121, December 1984. Such techniques may be extended with an external noise reference input as described in U.S. Pat. No. 6,546,099.

It takes the reference signal as inputs for the (non-)stationary background noise x1 and the signal z containing the desired speech with additive undesired (non-) stationary background noise. The input signal samples are Hanning-windowed on a frame basis and next transformed to the frequency domain by an FFT (Fast Fourier Transform). The two obtained (complex valued) spectra are denoted by Z(f) and X₁(f), and their spectral magnitudes are denoted by |Z(f)| and |X₁(f)|. Here, f is the frequency index of the FFT result. Internally, the post-processor 302 calculates from |Z(f)| a stationary part of the background noise spectrum by spectral minimum search (which is explained in R. Martin, “Spectral subtraction based on minimum statistics”, in Signal Processing VII, Proc. EUSIPCO, Edinburgh (Scotland, UK), September 1994, pages 1182 to 1185), which is denoted as |N(f)|. With |Y(f)| as the magnitude spectrum of its output, the post-processor 302 applies the following spectral subtraction rule to z1:

|Y(f)|=|Z(f)|−γ₂x(f)|X₁(f)|−γ₁|N(f)|.

The γ's are the so-called over-subtraction parameters (with typical values between 1 and 3), with γ₁ being the over-subtraction parameter for the stationary noise and γ₂ being the over-subtraction parameter for the non-stationary noise. The term χ(f) is a frequency-dependent correction term that selects only the non-stationary part from |X₁(f)|, so that the stationary noise is subtracted only once (namely only with |N(f)|). To calculate χ(f), an additional spectral minimum search is needed on |X₁(f)| yielding its stationary part |N₁(f)|, and then χ(f) is given by:

$$χ ( f ) = \frac{\vert {X}_{1} ( f ) \vert - \vert {N}_{1} ( f ) \vert}{\vert {X}_{1} ( f ) \vert} .$$

Alternatively, for simplicity reasons, it is possible to set γᵢ to 0 (and the calculation of |N(f)| can be avoided), and χ(f) to 1. In this way, also stationary and non-stationary noise components are suppressed. A reason to follow the equation for calculating |Y(f)| is to have a different over-subtraction parameter for the stationary noise part and the non-stationary noise part.

Simply the unaltered phase of z is taken for the phase of the output spectrum. Finally, the time domain output signal y with improved SNR is constructed from its complex spectrum, using a well-known overlapped reconstruction algorithm (such as, for example, in the above-mentioned document by S. F. Boll).

However, when placing the microphones 303, 304 very close together, the robustness of the beam former 301a starts to decrease. First, the speech level difference in the microphone powers Pu1 and Pu2 becomes negligible and it may be no longer possible to use the above equation Pu1>α*Pu2. Also the equation Pz>β*C*Px1 becomes unreliable, because the coherence function C becomes larger for the lower middle frequencies. If the beam former 301a has not converged well, the speech leakage in the noise reference signal causes the condition to be false, and there will be no update of the adaptive beam former 301a.

One way to overcome these problems is to place a microphone on each ear cup. The distance between the microphones 303, 304 will be large (typically 17 cm) and the coherence function C will be small (approximately 1) over a large frequency range. Equation P_{z}>βCPₓ₁ can then be used as a reliable in-beam detector.

Experiments have shown that this microphone positioning and the beam former 301a shown in FIG. 3 yield good and robust results, provided that both ear cups remain positioned on the ears. When one of the ear cups is removed (a situation which is likely to occur when the desired speaker wants to listen to another person in, for example, the same room), the speech of the desired speaker will be suppressed. The reason is that the beam former 301a is not adapted for speech, and the speech leakage in the reference signal of the beam former 301a causes the updates to stop (condition 2 of the in-beam detection is false), and this will result in speech suppression by the post-processor 302 (see the above equation for calculating |Y(f)|). To solve this, it may be advantageous to detect the ear-cup removal, bypass the beam-forming in that case and continue in one channel mode.

A solution for the above-described task of detecting ear-cup removal will be presented hereinafter.

This detection is based on the following recognition. The near-end speaker is relatively close to the microphones 303, 304 which are located symmetrically with respect to the desired speaker. This means that the microphone signals will have a large coherence for speech and will approximately be equal. For noise, the coherence between the two microphone signals will be much smaller.

This can be exploited by placing an adaptive filter between the two microphones 303, 304, as depicted in the arrangement 400 of FIG. 4.

FIG. 4 shows a single adaptive filter 401 for detecting ear-cup removal.

The microphone 304 signal u2 is delayed by Δ samples, with Δ typically being half a number of coefficients of the adaptive filter 401, wherein the impulse response hᵤ₁ᵤ₂(n) ranges from 0 to N−1. A delay unit is denoted by reference numeral 402; a combining unit is denoted by reference numeral 403. When the desired speaker is active, hᵤ₁ᵤ₂(Δ) will be large. It will typically be larger than 0.3 even during noisy circumstances. When the desired speaker is not active (for a longer time), hᵤ₁ᵤ₂(Δ) will become smaller than 0.3. More generally, for noise signals (except the ones that originate from noise sources that are very close by), hᵤ₁ᵤ₂(n) will be smaller than 0.3 for all n in the range of 0, . . . , N−1.

When one of the ear cups is removed and when it is assumed that the removed ear cup is still relatively close by, it is possible to see a peak in the impulse response hᵤ₁ᵤ₂(n) that is larger than 0.3, but now at a position that differs from Δ. For noise signals it still holds, again except for the ones that originate from noise sources that are very close by, that there will be no peak larger than 0.3 for all coefficients. The algorithm for detection of ear-cup removal then consists of the following steps (with peak detect typically 0.3):

if (peak>peak detect) and (peak location=Δ), then both ear cups are on the ears.

if (peak>peak detect) and (peak location≠Δ±1), then one of the ear cups has been removed.

if there is no peak larger than peak detect, then the desired speaker is not active and it is not necessary to change the detection state.

If it is detected that one of the ear cups has been removed and that it is assumed that the distance from the desired speaker's mouth to the removed ear cup is larger than the distance into the remaining ear cup at the ear, it is advantageously decided from the location of the peak whether the left or right ear cup has been removed.

Referring to FIG. 4, a peak will be detected in the impulse response hᵤ₁ᵤ₂(n) at the left of n=Δ when the left ear cup is removed and a peak at the right of n=Δ when the right ear cup is removed, because the adaptive filter 401 tries to compensate for the (extra) delay that has been introduced by the ear-cup removal.

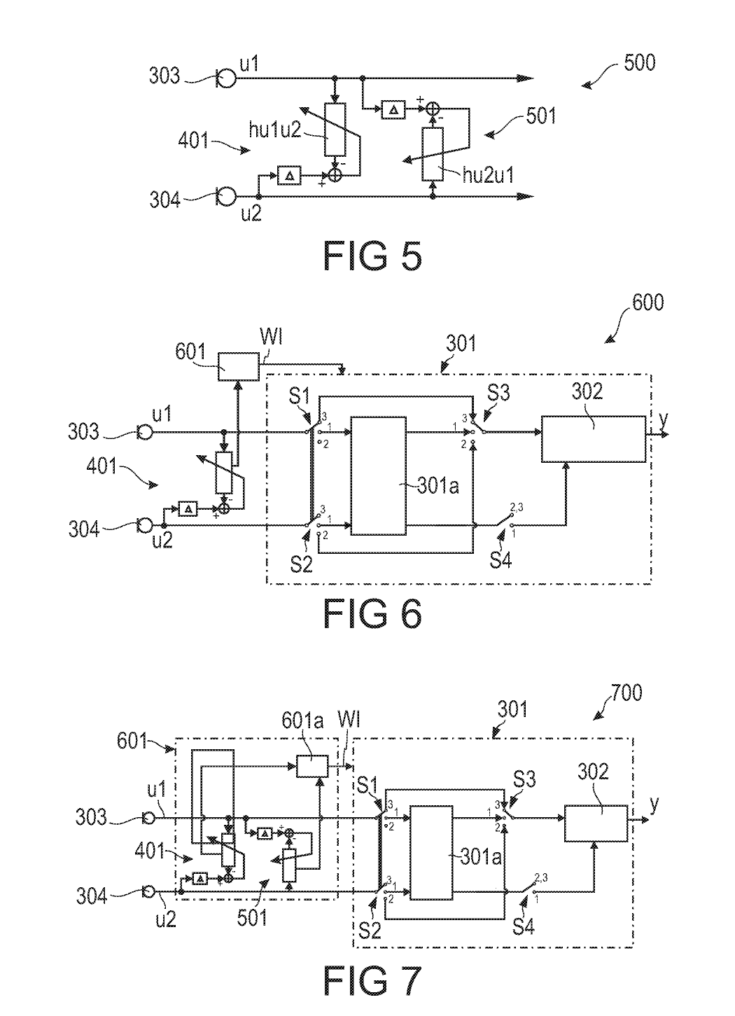

In this setup, the size of the peak will generally be different when the left ear cup is removed as compared with the case in which the right ear cup is removed. For example, if it is assumed in FIG. 4 that the left ear cup has been removed and the speech level of the microphone is lower than the speech level of the remaining ear cup, the peak will be large, because the input of the adaptive filter 401 is low as compared with the desired signal. In the opposite case, in which the right ear cup has been removed and it is assumed that the speech level of the right ear cup (desired signal for the adaptive filter) is low as compared with the left ear cup (input signal of the adaptive filter 401), the peak will be small. This asymmetry can be solved by advantageously using two adaptive filters of the same length with different subtraction points, as is shown in FIG. 5.

FIG. 5 shows an arrangement 500 having a first adaptive filter 401 and a second adaptive filter 501.

In this setup, the size of the peak will generally be different when the left ear cup is removed as compared with the case in which the right ear cup is removed. For example, if it is assumed in FIG. 4 that the left ear cup has been removed and the speech level of the microphone is lower than the speech level of the remaining ear cup, the peak will be large, because the input of the adaptive filter 401 is low as compared with the desired signal. In the opposite case, in which the right ear cup has been removed and it is assumed that the speech level of the right ear cup (desired signal for the adaptive filter 401) is low as compared with the left ear cup (input signal of the adaptive filter), the peak will be small.

Use of the two adaptive filters 401, 501 of the same length with different subtraction points as shown in FIG. 5 can solve this asymmetry.

One combined impulse response is derived from the respective impulse responses hᵤ₁ᵤ₂(n) and hᵤ₂ᵤ₁(n) as:

h(n)=hᵤ₁ᵤ₂(n)+hᵤ₂ᵤ₁(N−n)₁

In this equation, N is odd and n ranges from 0 to N−1. Detection of ear-cup removal and whether the left or right ear cup has been removed is similar as for the single adaptive filter case, but the situation for left and right ear-cup removal is the same now.

An embodiment of a processing device 600 according to the invention will now be described with reference to FIG. 6.

In addition to features that have already been described above, a detection unit 601a is provided. Furthermore, numbers “1”, “2” and “3” are used which are related to different ear-cup states. Number “1” may denote that both ear cups are on, number “2” may denote that the left ear cup is removed, and number “3” may denote that the right ear cup is removed.

The data-processing device 600 is thus an example of an algorithm using a single adaptive filter 401.

The data-processing device 700 of FIG. 7 shows an embodiment in which two adaptive filters 401, 501 are implemented.

In both cases, i.e. in FIGS. 6 and 7, the filter coefficients are sent to a detection unit 601a which indicates whether both ear cups are on the ears (mode 1), or whether the left ear cup (mode 2) or right ear cup (mode 3) has been removed. In this case, the beam-forming is dependent on the wearing information (WI). If no ear cup has been removed, switches S1, S2, S3 and S4 are in position 1, and the beam former 301a will be fully operational. If it is detected that either the left or the right ear cup has been removed, the signal of the other ear cup is directly fed to the post-processor 302 and in that case only stationary noise suppression will take place (that is to say, in the above equation for calculating |Y(f)|, the term γ2χ(f) |X1(f)| will be 0). The performance does not change if the user accidentally interchanges the left and right ear cups.

Fields of application of the embodiments of FIGS. 6 and 7 are, for example, stereo headphone applications used for speech communication.

It should be noted that use of the verb “comprise” and its conjugations does not exclude other elements or features and use of the article “a” or “an” does not exclude a plurality. Also elements described in association with different embodiments may be combined.

It should also be noted that reference signs in the claims shall not be construed as limiting the scope of the claims.

1. A device (120) for processing data for a wearable apparatus (100, 110), the device (120) comprising
an input unit (122) adapted to receive input data;
means (124) for generating information, referred to as wearing information (WI), which is based on sensor information and indicates a state, referred to as wearing state, in which the wearable apparatus (100) is worn; and
a processing unit (121) adapted to process the input data on the basis of said wearing information (WI), thereby generating output data.

2. The device (120) according to claim 1,
wherein the input unit (122) is adapted to receive at least one of the group consisting of audio data, acoustic data, speech data, music data, video data, image data, haptic data, tactile data, and vibration data as the input data.

3. The device (120) according to claim 1,
comprising an output unit adapted to provide the generated output data.

4. The device (120) according to claim 3,
wherein the output unit is adapted as a reproduction unit (114, 115) for reproducing the generated output data.

5. The device (120) according to claim 1,
wherein the means (124) for generating wearing information are adapted to generate at least one component of wearing information of the group consisting of how many ears a human user uses with the wearable apparatus (100, 110), which body part or parts a human user uses with the wearable apparatus (100), and whether an ear cup (112, 113) of the wearable apparatus (100) is removed from the user's head.

6. The device (120) according to claim 1,
wherein the means (124) for generating wearing information are adapted to receive sensor information from a detection unit (116, 117) adapted to automatically detect the wearing state of the wearable apparatus (100).

7. The device (120) according to claim 1,
wherein the means (124) for generating wearing information are adapted to receive sensor information from a detection unit (116, 117) adapted to detect the wearing information which is indicative of a user-controlled wearing state of the wearable apparatus (100, 110).

8. The device (120) according to claim 1,
wherein the processing unit (121) is adapted to generate the output data as stereo data when detecting that a human user uses both ears with the wearable device (100, 110), to generate the output data as mono data when detecting that a human user uses only one ear with the wearable device (100, 110), and to generate no output data when detecting that a human user uses no ear with the wearable device (100, 110).

9. The device (120) according to claim 1,
wherein the processing unit (121) is adapted to generate the output data as multiple channel data when detecting that a human user uses at least a predetermined number of ears with the wearable device (100, 110), the multiple channel data including at least three channels.

10. The device (120) according to claim 1,
wherein the processing unit (121) is adapted to generate the output data as an audio mix of the input data on the basis of detecting the number of ears the user uses with the wearable device (100).

11. The device (120) according to claim 1,
wherein the input unit (301) is adapted to receive audio signals (u1, u2), particularly speech signals, wherein a correlation between the audio signals (u1, u2) serves as a basis for generating the wearing information (WI).

12. The device (120) according to claim 11,
comprising two or more microphones (303, 304) arranged symmetrically with respect to an audio source, which microphones are adapted to supply the audio signals (u1, u2) emitted by the audio source.

13. The device (600, 700) according to claim 11,
wherein the means (601) for generating wearing information are adapted to generate the wearing information (WI) on the basis of an impulse response analysis of the received audio signals (u1, u2).

14. The device (600, 700) according to claim 13,
wherein the impulse response analysis of the received audio signals (u1, u2) is based on an output signal of at least one adaptive filter unit (401) applied to the audio signals (u1, u2).

15. The device (600, 700) according to claim 11,
wherein the processing unit (301) comprises a beam-forming unit (301a) adapted to provide beam-forming data based on the received audio signals (u1, u2).

16. The device (600, 700) according to claim 15,
wherein the beam-forming data supply is dependent on the wearing information (WI).

17. A wearable apparatus (100),
comprising a device (120) for processing data according to claim 1.

18. The wearable apparatus (100) according to claim 17,
realized as a portable device.

19. The wearable apparatus (100) according to claim 17,
realized as at least one of the group consisting of a GSM device, headphones, DJ headphones, earphones, a headset, an earpiece, an earset, a body-worn actuator, a gaming device, a portable audio player, a DVD player, a CD player, a hard disk-based media player, an Internet radio device, a public entertainment device, an MP3 player, a hi-fi system, a vehicle entertainment device, a car entertainment device, a portable video player, a mobile phone, a medical communication system, a body-worn device, a wellness device, a massage device, a speech communication device, and a hearing aid device.

20. A method of processing data for a wearable apparatus (100), the method comprising the steps of:
receiving input data;
generating information, referred to as wearing information (WI), which is based on sensor information and indicates a state, referred to as wearing state, in which the wearable apparatus (100, 110) is worn; and
processing the input data on the basis of said wearing information (WI), thereby generating output data.

21. A program element, which, when being executed by a processor (121), is adapted to control or carry out a method of processing data for a wearable apparatus (100), the method comprising the steps of:
receiving input data;
generating information, referred to as wearing information (WI), which is based on sensor information and indicates a state, referred to as wearing state, in which the wearable apparatus (100) is worn; and
processing the input data on the basis of said wearing information (WI), thereby generating output data.

22. A computer-readable medium, in which a computer program is stored which, when being executed by a processor (121), is adapted to control or carry out a method of processing data for a wearable apparatus (100), the method comprising the steps of:
receiving input data;
generating information, referred to as wearing information (WI), which is based on sensor information and indicates a state, referred to as wearing state, in which the wearable apparatus (100) is worn; and
processing the input data on the basis of said wearing information (WI), thereby generating output data.
